(19) United States
(12) Patent Application Publication
(10) Pub. No.: US 2003/0139240 A1
(43) Pub. Date: Jul. 24, 2003

(54) Drive wheel for an exercise machine

(76) Inventor: Chien-Liang Chen, Taichung (TW)

Correspondence Address: Alan B. Clement, Esq., HEDMAN & COSTIGAN, P.C., 1185 Avenue of the Americas, New York, NY, 10036, US

(21) Appl. No.: 10/056,341

(22) Filed: Jan. 24, 2002

(51) Int. Cl. F16H 55/30; F16H 55/49; F16H 7/20

(52) U.S. Cl. 474/152; 474/165; 474/170

(57) ABSTRACT

A drive wheel used with an exercise machine consists of a belt wheel (10), a drive element (20) and a cover (30). A non-circular recess (11) is defined in the belt wheel (10) to receive the drive element (20) inside the recess (11) and lock the drive element (20) in the drive element (20). The cover (30) selectively has multiple protrusions (31) to wedge into corresponding notches (13) defined in the belt wheel (10) and is detachably connected to the belt wheel (10) to enclose the drive element (20) inside the drive wheel by multiple fixing elements such as rivets (40).

### BACKGROUND OF THE INVENTION

1. Field of the Invention

The present invention relates to a drive wheel, and more particularly to a drive wheel for an exercise machine, which has a locking drive element mounted on the drive wheel to enhance the stability and useful life of the drive wheel.

2. Description of Related Art

With reference to FIGS. 6 and 7, a conventional drive wheel used in an exercise machine, such as an exercise bike, is composed of a wheel (50) and a drive plate (60).

The wheel (50) is usually made of plastic and has a hub (54), multiple spokes (52) and a rim (55). The rim (55) has an outer periphery (not numbered) and an inner periphery (not numbered). A groove (501) is defined around the outer periphery of the rim (55). A transmission belt (not show) is mounted around the wheel (50) inside the groove (501) in the rim (55). The drive plate (60) is imbedded in the hub (54) of the wheel (50). A hole (51) is defined in the center of the hub (54). The spokes (52) are evenly spaced around the hub (54) and connect the hub (54) and the rim (55). A rib (521) is formed on each side of each spoke (52) to enhance the strength of the wheel (50).

The drive plate (60) is made of metal and is imbedded inside the hub (54) when the wheel (50) is formed by injection molding around the drive plate (60). The drive plate (60) has a drive hole (61) defined in the center of drive plate (60) to correspond to the hole (51) in the hub (54). Multiple channels (62) are defined through the drive plate (60) around the drive hole (61). Each channel (62) is filled with plastic when the wheel (50) is molded around the drive plate (60) to securely hold the drive plate (60) within the wheel (50). A drive shaft (not show) is securely mounted in the drive hole (61) to transmit a rotating force applied to pedals (not shown) by a rider to the wheel (50).

However, the conventional drive wheel has following drawbacks:

1. Complex fabrication procedure and likely chance of producing a defective product:

Because the wheel (50) is formed around the drive plate (60), the drive plate (60) has to be suspended to mold of the wheel (50) successfully around the drive plate (60). However, the slightest error in concentric alignment of the drive plate (60) and the mold causes the wheel (50) to be uneven, which easily happens because the molding process is carried out with the drive plate (60) in a suspended situation. Moreover, the channels (62) of the drive plate (60) must be filled with plastic entirely to provide enough positioning efficiency to the drive plate (60), otherwise, the drive wheel is easily broken when the channels (62) are not completely filled by the plastic integral with the wheel (50). Therefore, the product fabrication procedure of the conventional drive wheel is complex and the rate of defective products is raised, too.

2. The elements cannot be replaced individually:

The drive plate (60) is enclosed inside the wheel (50) and cannot be readily separated from the wheel (50) so that individual elements of the conventional drive wheel are not replaceable and the quality of the elements of the conventional drive wheel cannot be controlled individually.

To obviate or mitigate the problems with the conventional drive wheel, the present invention provides a modified drive wheel that is produced easily and has excellent transmission stability.

### SUMMARY OF THE INVENTION

The main objective of the invention is to provide a drive wheel that is detachable and has excellent stability during rotating.

Other advantages and novel features of the invention will become more apparent from the following detailed description when taken in conjunction with the accompanying drawings.

### BRIEF DESCRIPTION OF THE DRAWINGS

FIG. 1 is an exploded perspective view of a drive wheel in accordance with the present invention;

FIG. 2 is a cross sectional front plan view of the drive wheel in FIG. 1;

FIG. 3 is an exploded perspective view of another embodiment of the drive wheel in accordance with the present invention;

FIG. 4 is an exploded perspective view of still another embodiment of the drive wheel in accordance with the present invention;

FIG. 5 is an operational perspective view of the drive wheel in accordance with the present invention in use with an exercise bike;

FIG. 6 is a perspective view in partial section of a conventional drive wheel in accordance with the prior art; and

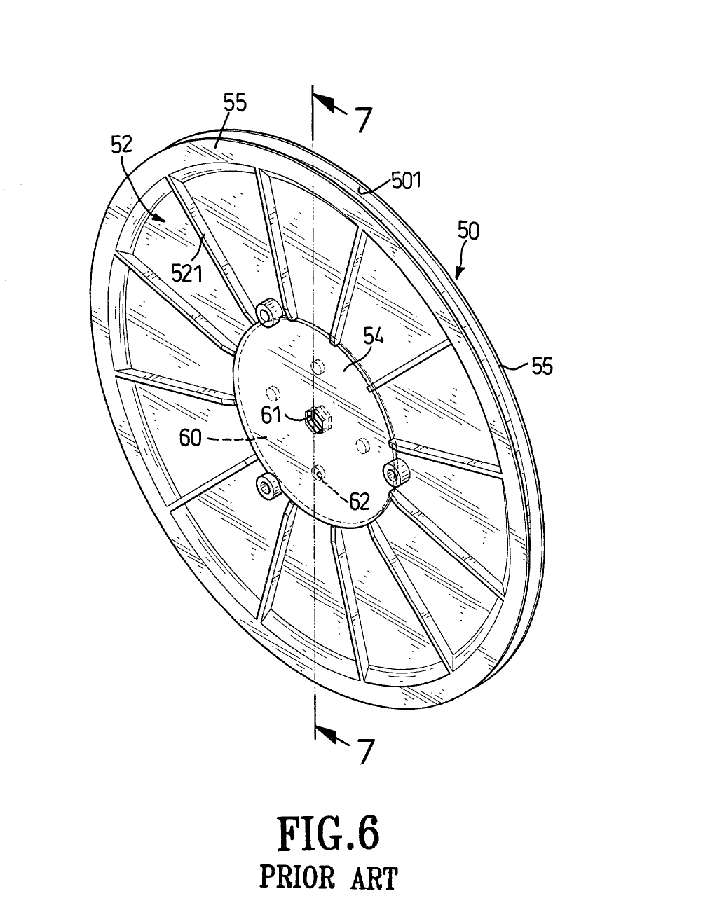

FIG. 7 is a cross sectional front plan view of the hub and spokes of the conventional drive wheel along line 7-7 in FIG. 6.

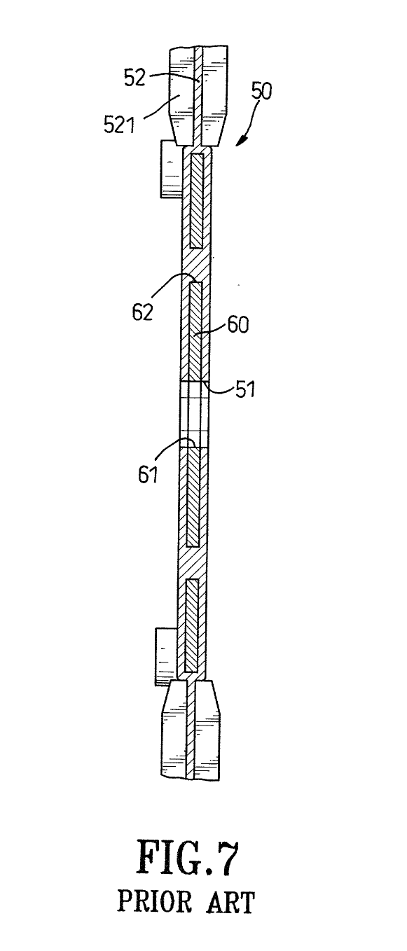

### DETAILED DESCRIPTION OF THE PREFERRED EMBODIMENT

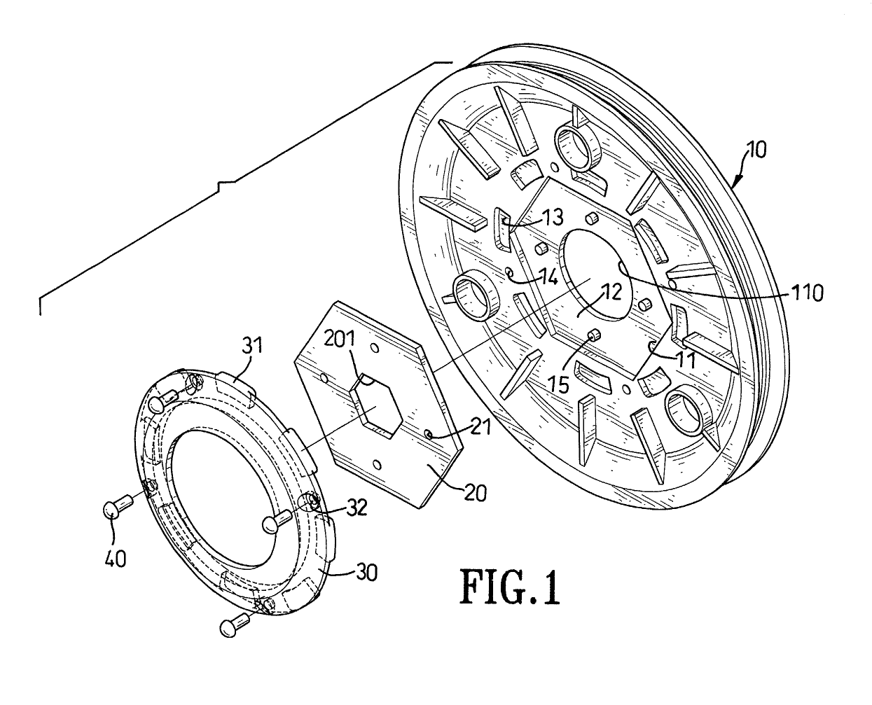

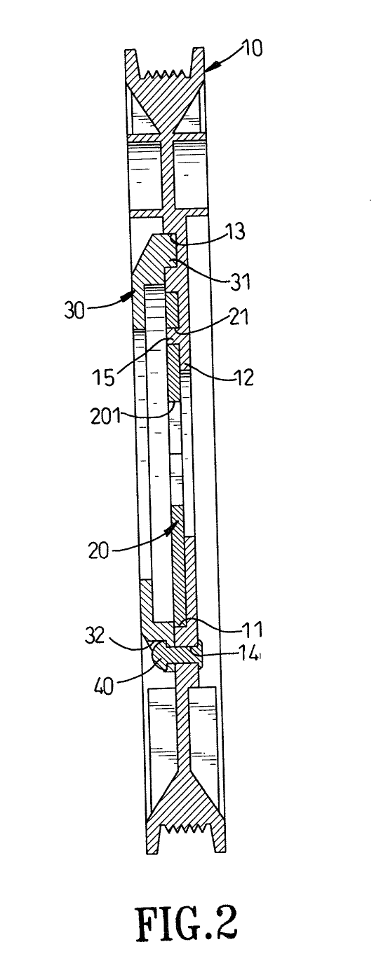

With reference to FIGS. 1 and 2 a drive wheel for an exercise machine comprises a belt wheel (10), a drive element (20) and a cover (30).

The preferred embodiment of the belt wheel (10) has a recess (11) defined in one side of the belt wheel (10). The recess (11) does not completely penetrate the belt wheel (10) so the recess has a bottom. The bottom of the recess constitutes a stop face (12). In the preferred embodiment the recess (11) is polygonal. A central hole (110) is defined in a center of the stop face (12) and a drive shaft (not show) passes through the central hole (110). Multiple notches (13) are evenly spaced and concentrically defined around the recess (11), and a first through hole (14) is defined between alternate adjacent notches (13). Additionally, multiple stubs (15) are formed on the stop face (12)

The drive element (20) is received in the recess (11) of the belt wheel (10) so that the drive element (20) is a polygonal plate corresponding to the recess (11) in the belt wheel (10) to lock the drive element (20) and the belt wheel (10) together. Then, the drive element (20) is able to smoothly drive or rotate the belt wheel (10) when a rider applies a rotary force to pedals (not shown) attached to the drive shaft. A polygonal hole (201) smaller than the central hole (110) in the wheel (10) is defined in a center of the drive element (20) to be engaged by the drive shaft of an exercise machine. Multiple stub holes (21) are defined in the drive element (20) around the polygonal hole (201) to correspond to and engage the stubs (15) on the stop face (12) of the wheel (10) to further lock the drive element (20) and the belt wheel (10) together.

The cover (30) is an annular ring that is mounted around the drive element (20) and securely holds the drive element (20) on the belt wheel (10). Multiple protrusions (31) are formed on one face of the cover (30) toward the belt wheel (10). The protrusions (31) correspond to and engage the notches (13) in the belt wheel (10) to lock the cover (30) and the belt wheel (10) in a fixed position with regard to each other. The drive element (20) is enclosed by the cover (30) inside the recess (11) in the belt wheel (10). Multiple second through holes (32) are defined in the cover (30) to correspond to the first through holes (14). Additionally, multiple fixing elements such as rivets (40) penetrate the first through holes (14) and the second through holes (32) to securely hold the whole drive wheel together.

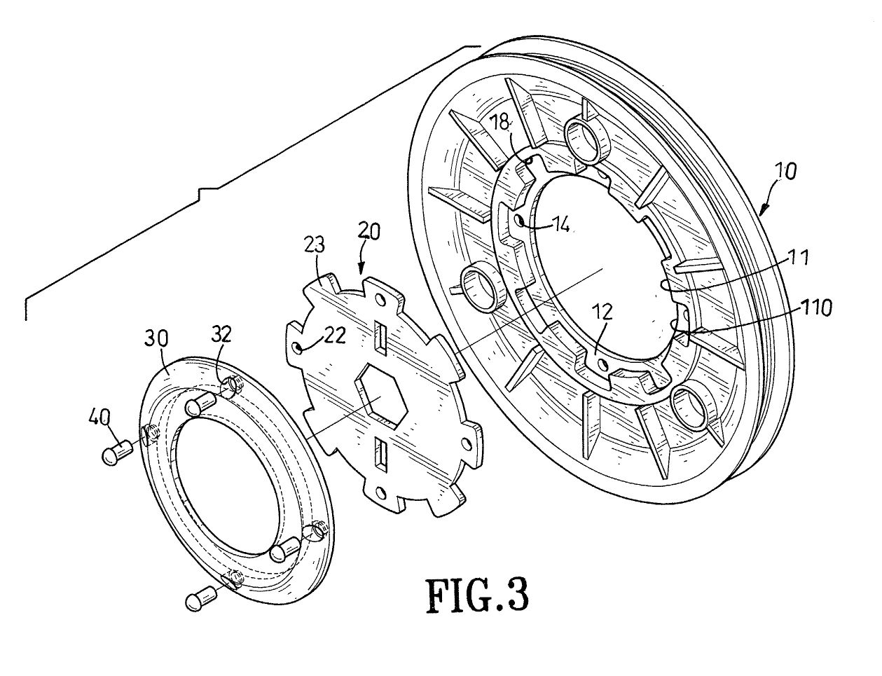

With reference to FIG. 3, the recess (11) in another embodiment of the belt wheel (10) in accordance with the present invention is tooth-shaped. Multiple cutouts (18) are defined around the recess (11). The cutouts (18) do not completely penetrate the belt wheel (10) so each cutout (18) has a bottom face. A first through hole (14) is defined in the bottom face every other cutout (18). The drive element (20) is also tooth-shaped and has multiple teeth (23) to engage the corresponding cutouts (18) in the recess (11) to lock the drive element (20) to the belt wheel (10). Additionally, multiple middle through holes (22) are defined in the drive element (20), and each middle through holes (22) is aligned with the corresponding first through hole (14) of the belt wheel (10) and the corresponding second through hole (32) of the cover (30). Then, rivets (40) penetrate the second, middle, and first through holes (32, 22, 14) respectively to lock all elements of the drive wheel together. In this embodiment, the belt wheel (10) does not have notches (13) and the cover (30) does not have protrusions (31).

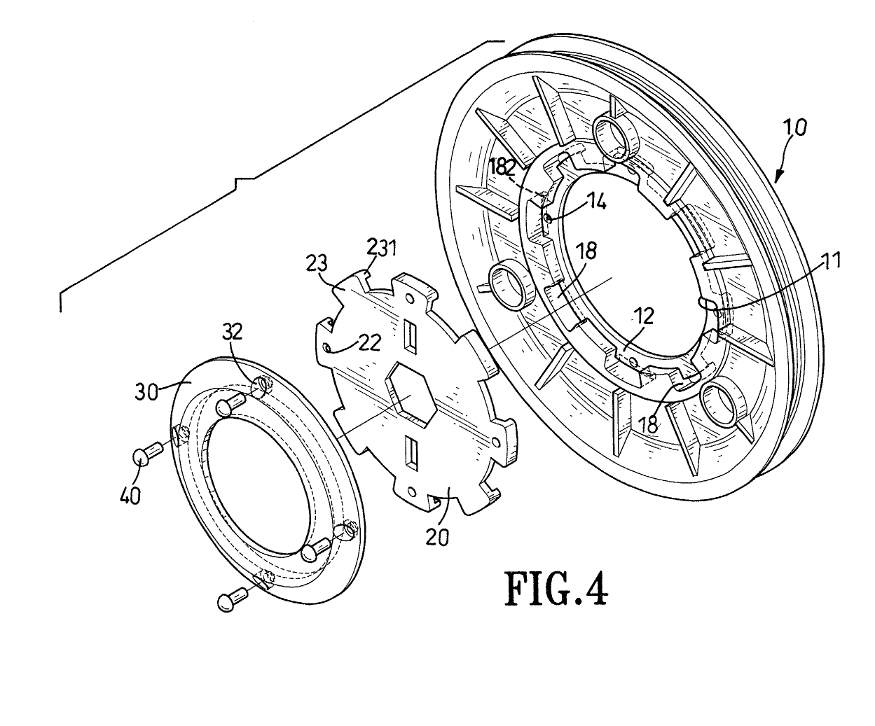

With reference to FIG. 4, this embodiment of the drive wheel has the same structure as the previous embodiment. However, each cutout (18) of the recess (11) has a slot (182) defined in the bottom of each cutout (18), and each tooth (23) of the drive element (20) has a flange (231) formed on a distal end of the tooth (23) to engage the slot (182) of the cutout (18). Whereby, the drive element (20) is further locked on the belt wheel (10) when the flanges (231) are inserted into the slots (182).

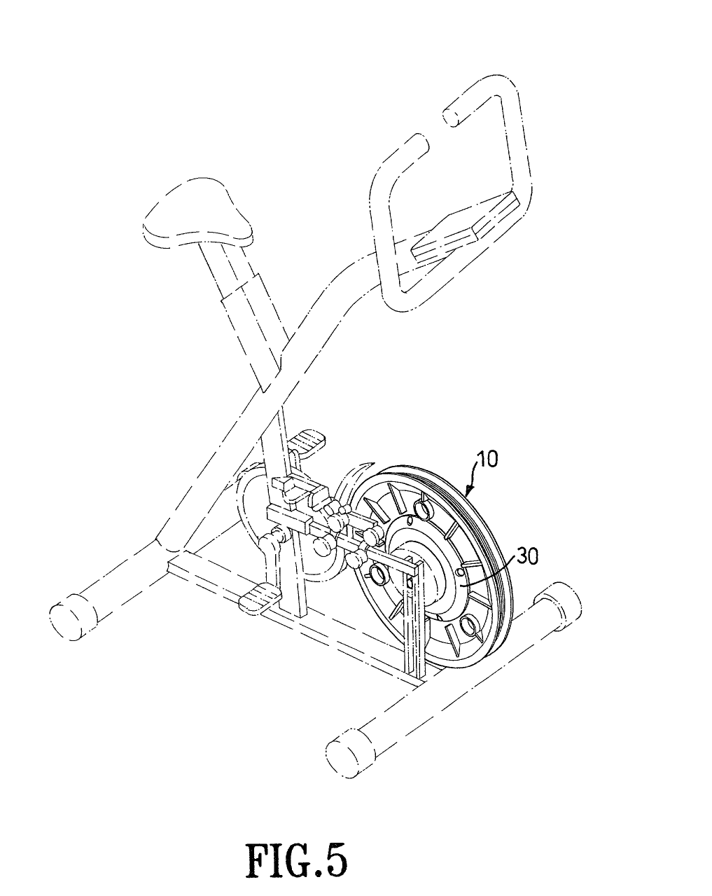

With reference to FIG. 5, the drive wheel is used on an exercise bike as a driven wheel, wherein a belt encloses a drive wheel and the driven wheel together. The belt loops around the outer groove in the belt wheel (10) and transmits the driving force between the drive wheel and the driven wheel. Because all elements of the drive wheel are well engaged with each other by combining the polygonal drive element (20) into the belt wheel (10), the drive wheel is endurable and has excellent stability, even when the drive wheel rotates too fast.

The drive wheel in accordance with the present invention has a simplified structure as described. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A drive wheel adapted for use on an exercise machine, and the drive wheel comprising:
a belt wheel (10) with a center of rotation having
a recess (11) having a bottom and defined in the belt wheel (10) at the center of rotation; and
a stop face (12) formed on the bottom of the recess (11);
a drive element (20) corresponding to and mounted inside the recess (11) in the belt wheel (10); and
a cover (30) detachably connected to the belt wheel (10) and enclosing the drive element (20) inside the belt wheel (10);
wherein the drive element (20) and the recess (11) mate with each other to ensure the rotatable stability of the drive wheel.

2. The drive wheel as claimed in claim 1, wherein the recess (11) and drive element (20) have a polygonal shape.

3. The drive wheel as claimed in claim 1, wherein the belt wheel (10) has multiple notches (13) defined in the bottom of the recess (11);
multiple protrusions (31) are formed on the cover (30) and each protrusion (31) engages the corresponding notch (13) in the belt wheel (10) to rotatably lock the cover (30) to the belt wheel (10) and laterally hold the elements of the drive wheel together.

4. The drive wheel as claimed in claim 3, wherein the belt wheel (10) further has multiple stubs (15) formed on the stop face (12) of the recess (11);
multiple stub holes (21) are further defined in the drive element (20) to engage the corresponding stubs (15) of the belt wheel (10) to rotatably lock the drive element (20) and the belt wheel (10) together.

5. The drive wheel as claimed in claim 4, wherein the drive element (20) is a hexagonal plate and the recess (11) is a hexagonal recess.

6. The drive wheel as claimed in claim 5, in which multiple rivets (40) penetrate the cover (30) and the belt wheel (10) to laterally combine the elements of the drive wheel.

7. The drive wheel as claimed in claim 1, wherein the recess (11) of the belt wheel (10) is tooth-shaped and has multiple cutouts (18) defined in an inner periphery of the recess (11), each cutout (18) has a bottom; and
the drive element (20) is tooth-shaped and has multiple teeth (23) to engage with the corresponding cutouts (18) in the recess (11) to rotatably lock the drive element (20) to the belt wheel (10).

8. The drive wheel as claimed in claim 7, wherein each cutout (18) further has a slot (182) defined in the bottom of the cutout (18); and
each tooth (23) of the drive element (20) has a flange (231) formed on the tooth (23) to engage the slot (182) of the cutout (18), whereby, the drive element (20) is further locked on the belt wheel (10).

9. The drive wheel as claimed in claim 8, in which multiple rivets (40) penetrate the cover (30), the drive element (20) and the belt wheel (10) to laterally combine the elements of the drive wheel.
